(19) United States
(12) Patent Application Publication
(10) Pub. No.: US 2025/0278613 A1
(43) Pub. Date: Sep. 4, 2025

(54) ASYNCHRONOUS OUTPUT GENERATION IN GENERATIVE ARTIFICIAL INTELLIGENCE MODELS

(71) Applicant: QUALCOMM Incorporated, San Diego, CA (US)

(72) Inventors: Sunny Praful Kumar PANCHAL, Toronto (CA); Apratim BHATTACHARYYA, San Diego, CA (US); Roland MEMISEVIC, Toronto (CA)

(21) Appl. No.: 18/667,988

(22) Filed: May 17, 2024

Related U.S. Application Data
(60) Provisional application No. 63/559,558, filed on Feb. 29, 2024.

(51) Int. Cl. G06N 3/0475

(52) U.S. Cl. CPC G06N 3/0475

(57) ABSTRACT

Certain aspects of the present disclosure provide techniques and apparatus for asynchronously generating outputs based on streaming data inputs using generative artificial intelligence models. An example method generally includes generating a representation of first streaming data. A response to the first streaming data is generated using a generative artificial intelligence model. Generally, the generated response to the first streaming data is based on previously received streaming data and includes one or more tokens identifying an action to perform in response to receipt of the first streaming data. One or more first actions are taken based on the response to the first streaming data.

### CROSS-REFERENCE TO RELATED APPLICATIONS

This application claims priority to and benefit of U.S. Provisional Patent Application Ser. No. 63/559,558, entitled “Asynchronous Output Generation in Generative Artificial Intelligence Models,” filed Feb. 29, 2024, and assigned to the assignee hereof, the entire contents of which are hereby incorporated by reference.

### INTRODUCTION

Aspects of the present disclosure relate to generative artificial intelligence models.

Generative artificial intelligence models can be used in various environments in order to generate a response to an input prompt (also referred to as a query or an input). For example, generative artificial intelligence models can be used in chatbot applications in which large language models (LLMs) are used to generate an answer, or at least a response, to an input prompt. Other examples in which generative artificial intelligence models can be used include, but are not limited to, a latent diffusion model, in which a model generates an image from an input text description of the content of the desired image, decision transformers, in which future actions are predicted based on sequences of prior actions within a given environment, or the like.

Generally, generative artificial intelligence models operate on a turn-by-turn basis. That is, a generative artificial intelligence model may be prompted (e.g., by a user of a computing system on which the generative artificial intelligence model executes) to generate a response to an input prompt. After the generative artificial intelligence model generates and outputs the response to the input prompt, the user of the computing system can input a subsequent prompt to the generative artificial intelligence model for processing. Because generative artificial intelligence models generally operate on a turn-by-turn basis, the scenarios in which generative artificial intelligence models are used may be limited to scenarios in which the generative artificial intelligence model and a user thereof operate sequentially and synchronously (e.g., in response to a generated output, where a user-generated prompt serves as an input into the generative artificial intelligence model and where the output of the generative artificial intelligence model serves as a prompt to which the user responds). Thus, generative artificial intelligence models may be unsuitable for processing interactions that are not performed on a turn-by-turn basis.

### BRIEF SUMMARY

Certain aspects of the present disclosure provide methods for asynchronously generating outputs for streaming data inputs using a generative artificial intelligence model. An example method generally includes generating a representation of first streaming data. A response to the first streaming data is generated using a generative artificial intelligence model. Generally, the generated response to the first streaming data is based on previously received streaming data and includes one or more tokens identifying an action to perform in response to receipt of the first streaming data. One or more first actions are taken based on the response to the first streaming data.

Certain aspects of the present disclosure provide methods for training a generative artificial intelligence model to asynchronously generate outputs for streaming data inputs. An example method generally includes receiving a training data set including a plurality of streaming data samples. Each respective streaming data sample is generally labeled with a description of activity depicted by the respective streaming data sample. The generative artificial intelligence model is trained to asynchronously generate a response to an input sample of streaming data based on the training data set and previously received streaming data. The trained generative artificial intelligence model is deployed.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of various aspects of the present disclosure and are therefore not to be considered limiting of the scope of this disclosure.

FIGS. 1A and 1B depict example architectures for asynchronously generating outputs based on streaming input data using a generative artificial intelligence model, according to aspects of the present disclosure.

FIG. 2 depicts an example timeline for asynchronously generating outputs based on streaming input data using a generative artificial intelligence model, according to aspects of the present disclosure.

FIG. 3 depicts an example architecture for asynchronously generating outputs based on streaming input data using a generative artificial intelligence model trained based on states in a state machine, according to aspects of the present disclosure.

FIG. 4 depicts an example timeline for asynchronously generating outputs based on streaming input data using a generative artificial intelligence model trained based on states in a state machine, according to aspects of the present disclosure.

FIG. 5 depicts example operations for asynchronously generating outputs based on streaming input data using a generative artificial intelligence model, according to aspects of the present disclosure.

FIG. 6 depicts example operations for training a generative artificial intelligence model to asynchronously generate outputs based on streaming input data, according to aspects of the present disclosure.

FIG. 7 depicts an example system on which aspects of the present disclosure may be implemented.

FIG. 8 depicts an example system on which aspects of the present disclosure may be implemented.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques for training and using generative artificial intelligence models to asynchronously generate outputs based on streaming input data (e.g., streaming video, with or without accompanying audio or textual content, streaming audio, with or without accompanying video or textual content, etc.).

Human-machine interaction may be performed in a variety of manners. In some examples, such as those used by chatbots or other text-based interactive environments, a turn-by-turn paradigm may be used. Turns generally alternate between a user of a computing system and the computing system itself (or generative artificial intelligence models deployed thereon) in order to allow a user of the computing system to interact with the computing system. In human-machine interactions based on a turn-by-turn paradigm, operations may be performed synchronously or otherwise in response to a defined input generated during any given turn of interaction between the user and the computing system.

While some human interactions, such as in live support systems, question-answering systems, or the like, may operate using a turn-by-turn paradigm, other types of human interaction may not be amenable to turn-by-turn-based processing of inputs associated with such interactions. For example, for physical exercise, there may be a variety of scenarios that prompt an output from a monitoring system, such as a pattern of motion compared to a target pattern, motivational encouragement, or the like. Further, some outputs may take into account prior activity and/or prior outputs generated in response to such prior activity. For example, if a user was instructed to move in a different manner at time t, and the user moves in that different manner at a later time t+Δt, an appropriate output may be to acknowledge that the user has moved in the instructed manner and to encourage the user to keep moving. In another example, if a user was instructed to move in a different manner at time t and still does not move in that different manner at time t+Δt, an appropriate output may be to point out to the user that the user's pattern of motion continues to deviate from the instructed manner. In another example, cooking may similarly not be amenable to a turn-by-turn-based processing paradigm, as various actions performed through the process of cooking may be preconditioned on the successful completion of specified precursor tasks, and factors such as elapsed time may affect the appropriate output generated by a monitoring system.

As discussed, generative artificial intelligence systems, such as large language models used in generating textual responses to textual queries, generally operate using a turn-by-turn paradigm. Because these generative artificial intelligence models respond to inputs synchronously, with the output of a response initiating a new input prompt entry turn for the user of these generative artificial intelligence models, generative models may be suitable for human-machine interaction that also uses a turn-by-turn interaction paradigm. However, these generative artificial intelligence models may not allow for asynchronous output generation, and thus may be unsuitable for tasks that do not use a turn-by-turn interaction paradigm.

Aspects of the present disclosure provide techniques that allow for generative artificial intelligence models to provide output asynchronously based on streaming data inputs, thus allowing for generative artificial intelligence models to be used in human-machine interaction paradigms that are not turn-based (or are at least not strictly turn-based). To do so, streaming inputs may continuously be converted from a raw input into a representation (e.g., a set of tokens, embeddings, etc.) that are input into a generative artificial intelligence model for processing. The generative artificial intelligence model can leverage temporal relationships between a current streaming input and a plurality of prior inputs to generate an output based on the streaming input. The output may generally include one or more special tokens identifying an action to be performed based on the streaming input. These special tokens may specify, for example, that no action is to be performed based on the current streaming input (and thus that the generative artificial intelligence model is to continue to monitor streaming inputs to determine when and what action to perform in the future). In another case, the special token may specify that an indication is to be output to the user of a generative artificial intelligence model. By doing so, aspects of the present disclosure may allow for generative artificial intelligence models to operate in a wider variety of operational paradigms in which synchronous turn-based generative artificial intelligence models cannot operate.

### Example Asynchronous Output Generation Using Generative Artificial Intelligence Models and Streaming Data Inputs

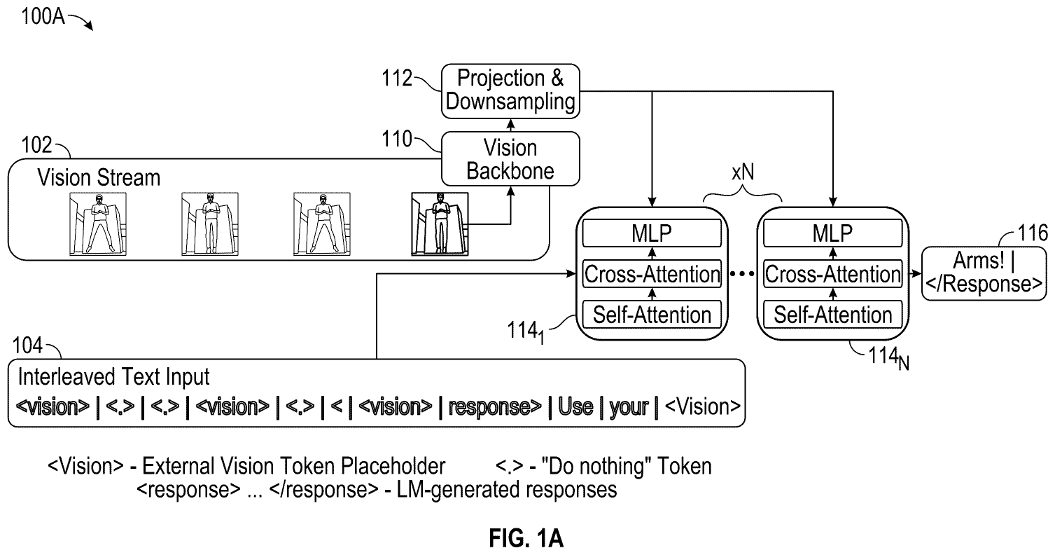

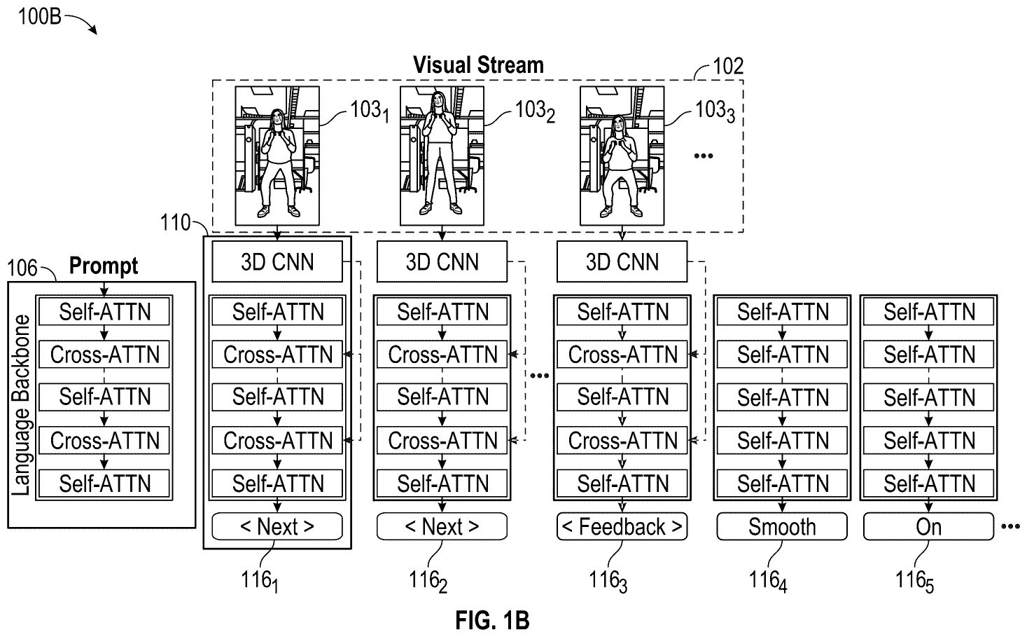

FIG. 1A depicts an example generative artificial intelligence model 100A for asynchronously generating outputs based on streaming input data, according to aspects of the present disclosure.

As illustrated, the generative artificial intelligence model 100A includes a vision backbone 110, a projection and downsampling block 112, and one or more attention layers 114₁-110_{N} (collectively referred to as attention layers 114). Generally, the vision backbone 110 ingests streaming visual data 102 (e.g., video, a continuous stream of images, etc.) and generates a representation of the streaming visual data that is usable by the attention layers 114 to generate an output based on the streaming visual data. For example, the vision backbone can convert the streaming visual data into embeddings or other representations of the streaming visual data. The representations of the streaming visual data may, for example, include features in a latent space, projected into a representation of the generative artificial intelligence model 100 describing objects detected in the visual content and the movement of the detected objects in the visual content. The representations of the visual content generated by the vision backbone may be projected and downsampled into compact representations in a latent space by the projection and downsampling block 112, and the latent space representations of the visual data can be fed into the attention layers 114 for processing.

In some aspects, an interleaved textual input 104 may additionally be input into the self-attention layers 114 to allow the attention layers 114 to asynchronously generate outputs based on streaming visual data. The interleaved textual input 104 may describe, for example, a sequence of streaming data and actions performed by the generative artificial intelligence model. Generally, the sequence of streaming data and actions performed by the generative artificial intelligence model may include a plurality of tokens corresponding to a sequence of inputs and actions so that the attention layers 114 can generate an output based on a current streaming visual data sample conditioned on prior streaming visual data samples and outputs generated by the generative artificial intelligence model 100A based on the prior streaming visual data. The tokens may include a streaming data token corresponding to an input, a continue observation token corresponding to the generative artificial intelligence model having determined that no output was warranted for the corresponding streaming video data input, or an output token corresponding to an indication to a user of the generative artificial intelligence model. In some aspects, the generative artificial intelligence model 100 may be trained to output the continue observation token as a default state and output other tokens (e.g., an output token) when ingested streaming data triggers a response (e.g., shows a deviation from a target sequence of actions, etc.).

The attention layers 114 generally use the latent space representations (or other tokenized representations) of the streaming visual data 102 and the interleaved textual input 104 to generate an output based on a current streaming visual data sample. As discussed, the output generated by the attention layers 114 may be temporally grounded based on the sequences of previous streaming visual data and outputs based thereon. The output generated by the attention layers 114 generally includes a special token indicating an action to be performed based on the input of the current streaming visual data sample into the generative artificial intelligence model 100A. The special token may indicate that no output is to be output to the user of the generative artificial intelligence model 100 or may indicate that a specified output (in a same or different modality as that of the streaming visual data) is to be output to the user of the generative artificial intelligence model 100A.

FIG. 1B illustrates a generative artificial intelligence model 100B configured to for asynchronously generating outputs based on streaming input data, according to aspects of the present disclosure. In the generative artificial intelligence model 100B, the input prompt describing the activity which the generative artificial intelligence model 100B is to monitor may be input into a language backbone 106 for processing. The language backbone may generate contextual information for the vision backbone 110 to use in generating an output in response to frames 103₁, 103₂, and 103₃ (and others not illustrated in FIG. 1B, collectively referred to as a frame 103) in the streaming visual data 102. Unlike the architecture 100A illustrated in FIG. 1A, the generative artificial intelligence model 100B may omit the inclusion of observations generated by the generative artificial intelligence model 100B in a text string which serves as an input into the generative artificial intelligence model 100B.

For each frame 103 in the streaming visual data 102, the vision backbone 110 can process the frame as discussed above to determine whether the movement of detected objects in the visual content matches a target motion for the activity identified by the input prompt and processed by the language backbone 106. In some aspects, the vision backbone may be a multidimensional neural network including two-dimensional and three-dimensional convolutional layers which can recognize motion and content in individual frames 103 in the streaming visual data 102 and thus allow for the appropriate feedback to be generated in response to the motion depicted in the frames 103. For example, as illustrated in FIG. 1B, the first frame 103₁ and the second frame 103₂ may result in the vision backbone generating respective outputs 116₁ and 116₂ as the continue observation token discussed above (illustrated in FIG. 1 as the special token “<next>”).

To preserve spatial information between different frames 103 and allow for subsequent observations of motion depicted in the streaming visual data 102 to be conditioned on prior observations of motion depicted in previous frames 103 in the streaming visual data 102, an adapter layer may be used to combine positional embedding data to features from previous layers of the vision backbone 110 to preserve spatial information. The features from the vision backbone may subsequently be projected and downsampled into an embedding with the same dimensionality as the embedding of the input prompt generated by the language backbone 106 so that a cross-attention layer in the vision backbone 110 can map visual information to the textual information generated by the language backbone 106. In some aspects, the fusion of visual and textual features may be performed after the vision backbone 110 generates a continue observation token.

Frame 103₃, as illustrated, triggers the generation of an output 116₃ including a feedback indicator, illustrated as the special token “<feedback>”. The feedback indicator generally indicates that the generative artificial intelligence model has determined that some output is to be generated based on processing the current frame 1033, conditioned on the observations generated from the previous frames 103₁ and 103₂ (amongst others not illustrated in FIG. 1B). For example, as discussed herein, the feedback indicator may be used to provide instructional feedback instructing the user that the user's motion is incorrect relative to a target motion and instructing the user on how to correct the user's motion, indicating that the user has corrected a previously incorrect motion, or the like. After the feedback indicator token is output, subsequent outputs 116₄ and 116₅, amongst others not illustrated in FIG. 1B, may be generated for output to the user. In some aspects, these tokens may be words or ports of words providing a textual response to the streaming visual data 102 including the feedback generated by the generative artificial intelligence model 100B.

To train the generative artificial intelligence model 100A or 100B, a training data set may be generated based on a corpus of streaming data samples labeled with an output (or classification of an output) associated with each sample in the corpus of streaming data samples. In some aspects, the universe of outputs may be derived from states in a state machine used to analyze the streaming data. For example, in examples in which the generative artificial intelligence model 100A or 100B is used as a virtual exercise coach, the state machine may include an initial state corresponding to the beginning of a portion of a workout (e.g., a specific block of movement), a terminal state corresponding to the end of a portion of the workout, and one or more states associated with different types of motion depicted in visual data relative to a target motion. A sequence of streaming data that conforms to a target motion (e.g., corresponding to the user correctly performing the workout) may be associated with a state in the state machine triggering no output, an output indicating that the user is correctly performing the workout, or an output encouraging the user to continue, for example. A sequence of streaming data showing a transition from an incorrect motion to a correct motion may likewise be associated with a state in the state machine (or a transition between states in the state machine) triggering the generation of an output confirming that the user is now correctly performing the workout. In another example, a sequence of streaming data showing a constant sequence of incorrect performance of the workout may be associated with a state in the state machine triggering the generation of an output instructing the user to perform the workout differently (e.g., with different form, speed, and/or breathing). It should be recognized that the foregoing are examples of states in a state machine monitoring the performance of a sequence of activity, and the training data set may include other types of activity based on which the generative artificial intelligence model 100A or 100B is trained. Further, it should be recognized that the generative artificial intelligence model 100A or 100B may be trained to monitor and provide feedback for a variety of activities which can be described by a state machine, such as the performance or execution of a variety of processes (e.g., the performance of an instrument, execution of a manufacturing process, and so on).

In some aspects, the training data set may be augmented with additional information identifying, where appropriate, specific deviations from a target motion. Using jumping jacks as an example, deviations from a target motion may include detection of leg motion but no corresponding arm motion. In such a case, the output with which the sequence of streaming visual data is associated may include an indication that the user should introduce arm motion into the exercise. In another example, for a squat, deviations from the target motion may include squatting too low, not squatting enough, deviations from how the back is positioned, or the like. Each of these deviations may be associated with an output specifying a correction to the user's form or other motion. To augment the training data set, various techniques can be used. In some examples, the training data set may be augmented manually with these outputs and information about deviations from a target motion. In another case, various vision-based machine learning models can be used to detect and/or predict subject motion and compare such motion to an a priori defined target motion (or range of motion).

In some aspects, the training data set may be generated based on a question-answer paradigm. To do so, sequences of streaming data may be analyzed based on a set of high-level and granular questions. High-level questions may, for example, be used to determine whether a subject depicted in a sequence of streaming data is correctly performing an exercise, to describe the exercise the subject depicted in the sequence of streaming data is performing, and describe (at a high level) why the subject is correctly or incorrectly performing an exercise. More granular questions, which may provide richer data for the generative artificial intelligence model 100A or 100B, may focus on specific aspects of subject motion, such as a speed at which the subject is performing an exercise, the positioning of the subject's body in relation to a target position for an exercise, whether the subject is actually performing the exercise, and the like.

In some aspects, the generative artificial intelligence model 100A or 100B may be trained to generate outputs in a different modality than the modality associated with the streaming data input. For example, the generative artificial intelligence model 100A or 100B may generate an output in a textual or audio modality for an input received in a video modality. A system using the output of the generative artificial intelligence model 100A or 100B may determine how to present the output generated by the generative artificial intelligence model 100A or 100B. For a textual output, for example, the system can overlay the textual output on top of a video display, output the textual output in a dedicated panel, convert the textual output to machine-generated speech output, or the like.

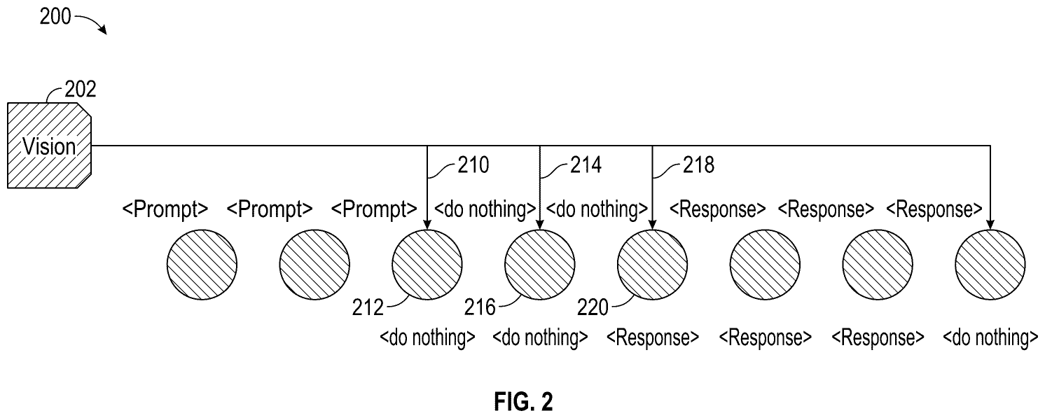

FIG. 2 depicts an example timeline 200 for asynchronously generating outputs based on streaming input data using a generative artificial intelligence model, according to aspects of the present disclosure.

As illustrated, a streaming video input 202 may be represented as a sequence of individual streaming data samples which may be independently processed by the generative artificial intelligence model 100A or 100B (discussed above with respect to FIGS. 1A and/or 1B). Each streaming data sample may be converted into a representation, such as a set of tokens describing the streaming data sequence, an embedding of visual data, or the like, and may be fed into the generative artificial intelligence model 100A or 100B along with information about previous streaming data sequences and outputs generated based thereon. By doing so, the generative artificial intelligence model can generate outputs based on current streaming data that are temporally grounded relative to, or at least also based on, previous streaming data and previously generated outputs. By doing so, aspects of the present disclosure may allow for a generative artificial intelligence model to generate outputs that bear some relationship to previously processed data inputs (in a stream) instead of treating each individual data input (in the stream) in isolation.

In the timeline 200, a first streaming data input 210 may be processed by the generative artificial intelligence model 100A or 100B to generate a first output 212. The first streaming data input 210 may be processed based, at least in part, on previously received data inputs (in the stream, as illustrated) and may result in the generation of the first output 212 including a continue observation token. As discussed, the continue observation token may indicate that a system using the generative artificial intelligence model 100A or 100B need not indicate an output to a user based on the first streaming data input 210, but instead may simply continue observing subsequent streaming data inputs to determine when an output is warranted. In exercise coaching examples, such a scenario may arise when the user performs a single repetition of an exercise incorrectly. In such cases, the continue observation token may be output so as to allow for continued observation and indication of an output to the user if subsequent repetitions of the exercise are performed incorrectly.

Likewise, a second streaming data input 214 may subsequently be processed by the generative artificial intelligence model 100A or 100B to generate a second output 216. Similar to the first streaming data input 210 and the first output 212, the second streaming data input 214 may result in the generation of a continue observation token as the second output 216. In this case, however, the generation of the continue observation token as the second output 216 by the generative artificial intelligence model 100 may be grounded by or otherwise based on the first output 212 and the first streaming data input 210.

As illustrated, a third streaming data input 218 may subsequently be processed by the generative artificial intelligence model 100A or 100B to generate a third output 220. In this case, the third streaming data input 218 (along with the previously processed streaming data inputs 210, 214 and corresponding outputs 212, 216) may prompt the generation of an output token that triggers a system using the generative artificial intelligence model 100A or 100B to output an indication to the user. In this case, the output token may be used to signal that an indication to output to the user is included in the output generated by the generative artificial intelligence model 100A or 100B. In some aspects, the third output 220 may include the output token and one or more textual tokens including the generated output to be output to the user. Returning to the exercise coaching example, the third output 220 may be generated, for example, when the streaming data inputs 210, 214, and 218 consistently show a pattern of the user failing to properly perform an exercise (e.g., displaying motion that does not match a target motion, performing repetitions too slowly or quickly, breathing incorrectly, etc.).

While FIG. 2 illustrates the generation of outputs 212, 216, 220 in response to streaming data inputs 210, 214, 218, respectively, it should be recognized that the generative artificial intelligence models described herein may generate such outputs based on these streaming inputs and/or other data. For example, the generative artificial intelligence models described herein may be able to generate outputs based on predictions of future activity alone or in conjunction with streaming data inputs 210, 214, and 218 (amongst others) showing past and current activity. In another example, the generative artificial intelligence models described herein may be trained to generate outputs based on long-term historical data, such as data from previous sessions of user activity or the like

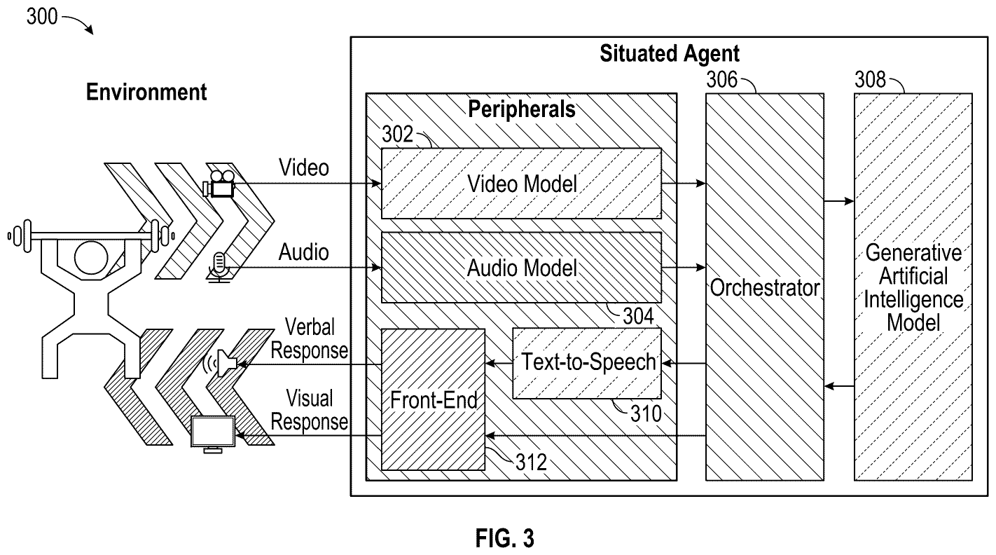

FIG. 3 depicts an example architecture 300 for asynchronously generating outputs based on streaming input data using a generative artificial intelligence model trained based on states in a state machine, according to aspects of the present disclosure.

As illustrated, the architecture 300 ingests streaming data in one or more data modalities for processing and asynchronous response generation. For example, the streaming data may include one or more of video data or audio data, amongst other types of streaming data, which may be input into a video model 302 (also referred to as a “vision model”) and an audio model 304 (also referred to as a “speech model”) (and/or other models, as appropriate) for processing. The video model 302 and the audio model 304 may ingest data at any defined sampling rate (e.g., 16 Hz for the video model 302, 16 kHz for the audio model 304, etc.). The video model 302 and the audio model 304 may generate a latent space representation of the input video data and the input audio data, respectively, for processing by a state-based orchestrator 306, which may operate at a sampling rate less than that of the video model 302 and/or the audio model 304 (e.g., at 4 Hz). Generally, the latent space representation may be a representation of the input video data and/or the input audio data (or other streaming data, as appropriate) that is compressed into a reduced-size space relative to the size of the input data.

The state-based orchestrator 306 may be a machine learning model trained to generate an output prompt usable by a generative artificial intelligence model 308 to ground the generative artificial intelligence model 308 (e.g., a language model) according to a detected state in a state machine representation of a sequence of actions monitored by the state-based orchestrator 306. For example, in examples in which the architecture 300 is used to deploy a virtual exercise coach, the state machine based on which the state-based orchestrator 306 is trained may include an initial state corresponding to the beginning of a portion of a workout (e.g., a specific block of movement), a terminal state corresponding to the end of a portion of the workout, and one or more states associated with different types of motion depicted in visual data (e.g., a current state) relative to a target motion (e.g., a target state). A sequence of streaming data that conforms to a target motion (e.g., corresponding to the user correctly performing the workout) may be associated with a state in the state machine triggering no output, an output indicating that the user is correctly performing the workout, or an output encouraging the user to continue, for example. A sequence of streaming data showing a transition from an incorrect motion to a correct motion may likewise be associated with a state in the state machine (or a transition between states in the state machine) triggering the generation of an output confirming that the user is now correctly performing the workout. In another example, a sequence of streaming data showing a constant sequence of incorrect performance of the workout may be associated with a state in the state machine triggering the generation of an output instructing the user to perform the workout differently (e.g., with different form, speed, and/or breathing) or change to a different exercise/movement.

Generally, the state-based orchestrator 306 may allow for the generative artificial intelligence model 308 to generate responses to streaming data asynchronously based on the current state associated with an observed sequence of actions and previously captured data. The generative artificial intelligence model 308 may be trained to generate an appropriate response to an observed sequence of actions, grounded or otherwise based on the current state and previous states in the state machine which the state-based orchestrator 306 detected. For example, the generative artificial intelligence model 308 may be trained to identify feedback events based on current and prior states in a sequence of actions identified by the state-based orchestrator 306. In some aspects, these feedback events may include a transition from a first state to a second state, a continuous amount of time in which user action remains in a particular state, or the like. For example, in an exercise coaching application, the generative artificial intelligence model can generate outputs corresponding to when a user transitions from a correct form for an exercise to an incorrect form for that exercise (e.g., with instructions on how to correct form), when a user transitions from an incorrect form for an exercise to a correct form for that exercise (e.g., with acknowledgment that the user has corrected his or her form), when a user continues to perform an exercise incorrectly, and the like.

The output of the generative artificial intelligence model 308 may be output to one or more of a text-to-speech engine 310 or a front-end 312 for pre-processing and output to the user of the architecture 300. The text-to-speech engine 310 may convert a generated textual response to an audio output which is output (e.g., via one or more connected sound devices) to the user. Meanwhile, the front-end 312 may output the textual response generated by the generative artificial intelligence model 308 as a visual output for the user to see (e.g., overlaid on a video stream, output in a dedicated text box or other repository for textual content, etc.).

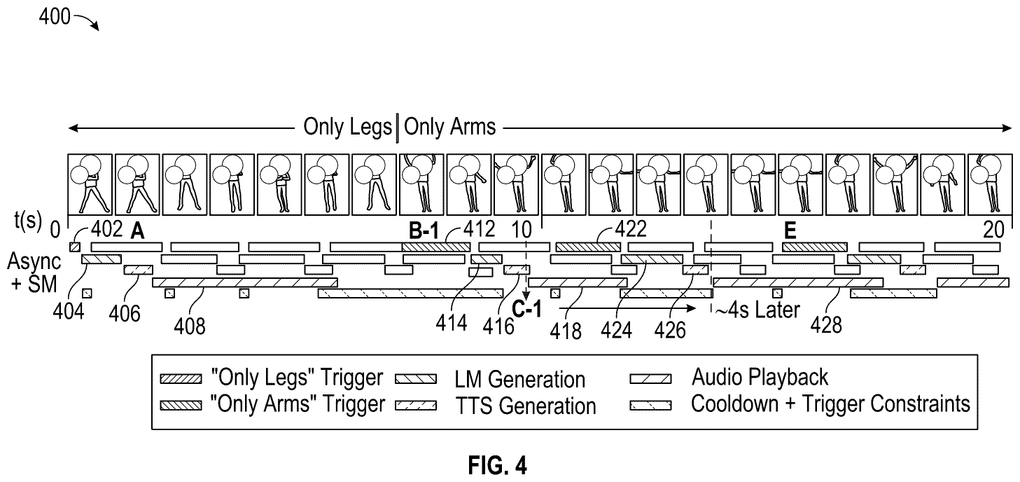

FIG. 4 depicts an example timeline 400 for asynchronously generating outputs based on streaming input data using a generative artificial intelligence model trained based on states in a state machine, according to aspects of the present disclosure.

In the example timeline 400, the user has been instructed to perform jumping jacks, and a state-based orchestrator and a generative artificial intelligence model (e.g., the orchestrator 306 and generative artificial intelligence model 308, respectively, illustrated in FIG. 3) use ingested streaming data to asynchronously generate a response based on a state in which the ingested streaming data is classified or otherwise mapped. As illustrated, a sequence of user action depicts data showing that the user is performing jumping jacks without any arm movement, which the orchestrator places in an incorrect action state (e.g., a transition from an initial action state to an incorrect action state in the state machine defining an exercise sequence). Thus, the orchestrator generates an “only arms” trigger 402 corresponding to an asynchronous detection of incorrect form for the jumping jacks exercise. The “only arms” trigger 402 may be used at block 404 to trigger the generation of a response by the generative artificial intelligence model, and the generated response may be processed at block 406 using a text-to-speech engine to generate an audio response 408 to the user indicating that the user is performing the exercise incorrectly and instructing the user how to perform the exercise correctly.

The example timeline 400 may progress with ingesting and analyzing further streaming data inputs and asynchronously generating outputs related to those inputs. In some aspects, as discussed above, the generative artificial intelligence model may generate an output including a special token indicating that no response is to be output to the user. In the timeline 400 illustrated in FIG. 4, the output of another response generated by the generative artificial intelligence model may be triggered based on the transition of user motion from one incorrect action state (e.g., an “only arms” state) to another incorrect action state (e.g., a “only legs” state). In this case, the initial transition from the “only arms” state to the “only legs” state may prompt the orchestrator to generate an “only legs” trigger 412. The “only legs” trigger 412 may be used at block 414 to trigger the generation of a response by the generative artificial intelligence model, and the generated response may be processed at block 416 to generate an audio response 418 to the user indicating that the user is performing the exercise incorrectly (but in a different way than previously indicated in the audio response 408) and instructing the user how to perform the exercise correctly.

In the example timeline 400, the user continues to perform the exercise incorrectly after the output of the audio response 418 to the user. Thus, at a later point in time, the orchestrator ingests streaming data based on which another “only legs” trigger 422 is triggered and output to a generative artificial intelligence model for processing at block 424. The output of the generative artificial intelligence model generated at block 424 may include a textual response indicating that the user is still performing the exercise incorrectly, as the generative artificial intelligence model may take into account prior states and prior generated outputs in determining the output to generate for a present streaming data input, as discussed above. The generated response may be processed at block 426 to generate an audio response 428 to the user indicating that the user is still performing the exercise incorrectly.

### Example Operations for Asynchronous Output Generation Using Generative Artificial Intelligence Models and Streaming Data Inputs

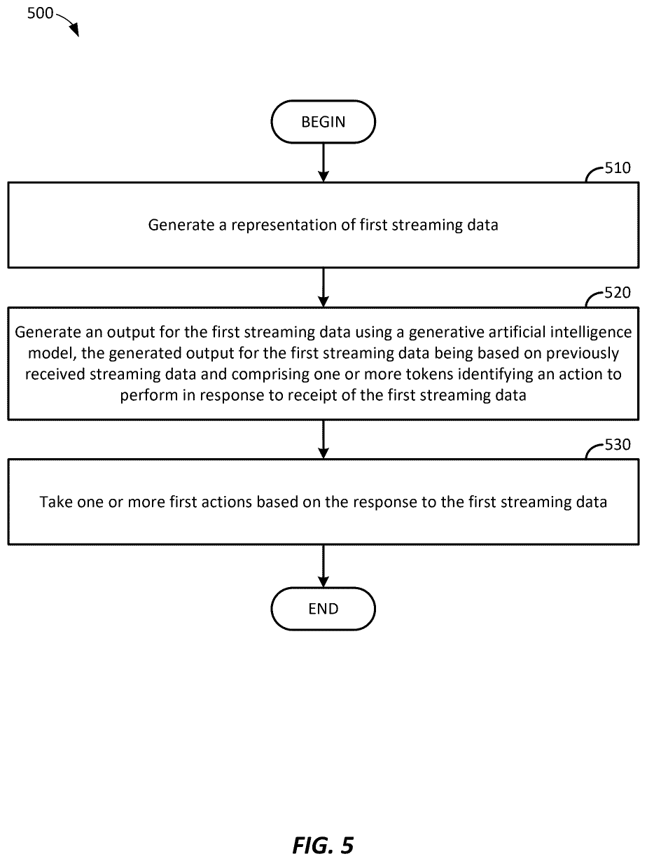

FIG. 5 illustrates example operations 500 for asynchronously generating outputs based on streaming data inputs using generative artificial intelligence models (e.g., the generative artificial intelligence models 100A or 100B illustrated in FIGS. 1A or 1B), according to aspects of the present disclosure. The operations 500 may be performed, for example, by a computing system on which a generative artificial intelligence model is deployed to generate inferences based on streaming data inputs, such as a smartphone, a tablet computer, a laptop, a server or cluster of servers, a cloud computing instance, or the like.

As illustrated, the operations 500 may begin at block 510, with generating a representation of first streaming data. In some aspects, generating the representation of the first streaming data includes generating one or more input tokens representing the first streaming data.

At block 520, the operations 500 proceed with generating a response to the first streaming data using a generative artificial intelligence model. Generally, the generated response to the first streaming data may be generated by the generative artificial intelligence model based on previously received streaming data and may include one or more tokens identifying an action to perform in response to receipt of the first streaming data.

At block 530, the operations 500 proceed with taking one or more first actions based on the response to the first streaming data.

In some aspects, wherein the first streaming data comprises streaming video data and wherein the response to the first streaming data comprises a continue observation token.

In some aspects, the operations 500 further include, when the response includes the continue observation token, generating a representation of second streaming data. A response to the second streaming data is generated using the generative artificial intelligence model. Generally, the generated response to the second streaming data may be generated based on at least the first streaming data and the second streaming data. One or more second actions are taken based on the response to the second streaming data.

In some aspects, taking the one or more second actions based on the response to the second streaming data may include outputting the response in a modality different from a modality associated with the first streaming data and the second streaming data.

In some aspects, the response to the first streaming data comprises an output response token indicating that the response is to be output to a user of a computing system from which the first streaming data was received.

In some aspects, the response to the first streaming data includes a response related to a previously generated response generated by the generative artificial intelligence model based on the previously received streaming data.

In some aspects, wherein the generative artificial intelligence model comprises a model trained to generate at least one of textual responses or audio responses to streaming video inputs.

In some aspects, the generative artificial intelligence model comprises a model trained to generate the response asynchronously and in parallel with capturing at least second streaming data.

In some aspects, generating the response to the first streaming data includes identifying a state in a state machine corresponding to the first streaming data. Generally, the state may be one of a plurality of states in the state machine describing a sequence of activity monitored by the generative artificial intelligence model. The response may be generated based on the identified state.

In some aspects, generating the response based on the identified state comprises generating the response based on a comparison of the identified state to a target state for the sequence of activity monitored by the generative artificial intelligence model.

In some aspects, generating the response based on the identified state comprises generating the response based on a determination that the identified state is identical to a previous state identified by the generative artificial intelligence model for a previous streaming input. For example, when the identified state matches a target state for the sequence of activity, generating the response may include generating affirmative feedback acknowledging that the user is performing the sequence of activity correctly.

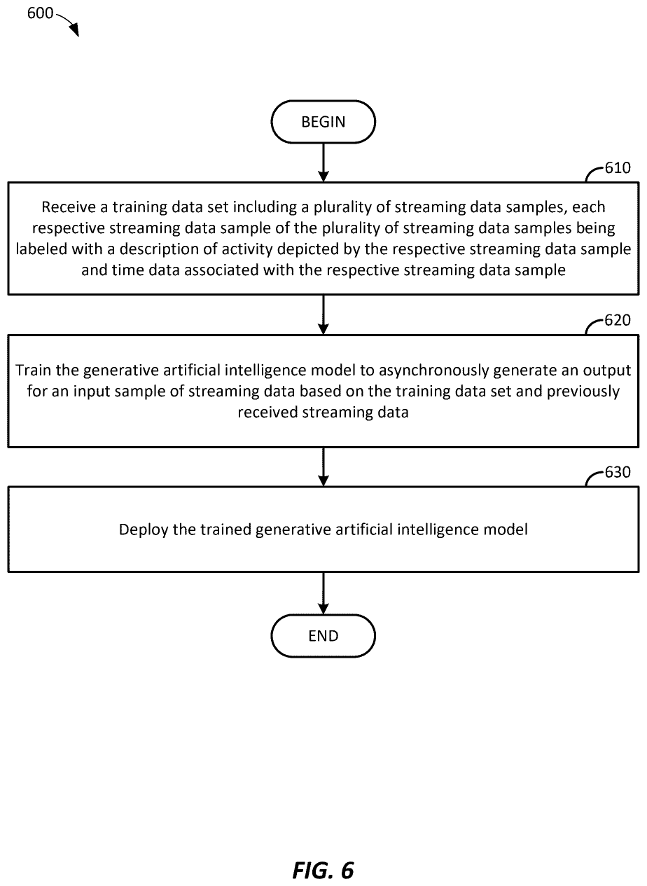

FIG. 6 depicts example operations 600 for training a generative artificial intelligence model to asynchronously generate outputs based on streaming input data, according to aspects of the present disclosure. The operations 600 may be performed, for example, by a computing system capable of training a machine learning model, such as a cloud computing instance, a server computer, a cluster of computing devices, or the like.

As illustrated, the operations 600 begin at block 610 with receiving a training data set including a plurality of streaming data samples. Generally, each respective streaming data sample may be labeled with a description of activity depicted by the respective streaming data sample and time data associated with the respective streaming data sample.

At block 620, the operations 600 proceed with training the generative artificial intelligence model to asynchronously generate a response to an input sample of streaming data based on the training data set and previously received streaming data.

In some aspects, training the generative artificial intelligence model includes generating, for each respective streaming data sample, a respective set of tokens representing the respective data sample. The generative artificial intelligence model is trained based on the respective set of tokens representing the respective data sample and the description of activity depicted by the respective streaming data sample.

At block 630, the operations 600 proceed with deploying the trained generative artificial intelligence model.

In some aspects, the description of activity depicted by the respective streaming data sample comprises a state in a state machine identifying an action to be performed based on the respective streaming data sample. In some aspects, the respective streaming data sample comprises streaming video data and wherein the state in the state machine comprises a continue observation state. In some aspects, the state in the state machine comprises a response output state corresponding to detection of a difference between a target state and a state identified in the respective streaming data sample.

In some aspects, the generative artificial intelligence model comprises a model trained to generate at least one of textual responses or audio responses to streaming video inputs.

### Example Processing Systems for Asynchronous Output Generation Using Generative Artificial Intelligence Models and Streaming Data Inputs

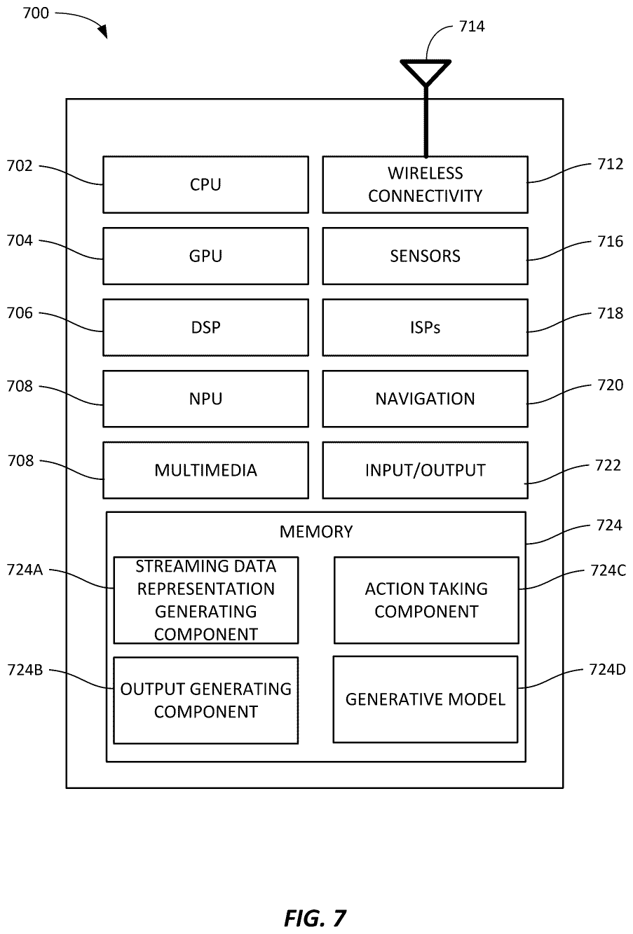

FIG. 7 depicts an example processing system 700 for asynchronously generating outputs based on streaming data inputs using generative artificial intelligence models, such as described herein for example with respect to FIG. 5.

The processing system 700 includes a central processing unit (CPU) 702, which in some examples may be a multi-core CPU. Instructions executed at the CPU 702 may be loaded, for example, from a program memory associated with the CPU 702 or may be loaded from a memory 724.

The processing system 700 also includes additional processing components tailored to specific functions, such as a graphics processing unit (GPU) 704, a digital signal processor (DSP) 706, a neural processing unit (NPU) 708, a multimedia processing unit 710, and a wireless connectivity component 712.

An NPU, such as the NPU 708, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPUs), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other estimative models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong estimation involves propagating back through the layers of the model and determining gradients to reduce the estimation error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 708 is a part of one or more of the CPU 702, the GPU 704, and/or the DSP 706.

In some examples, the wireless connectivity component 712 may include subcomponents, for example, for third generation (3G) connectivity, fourth generation (4G) connectivity (e.g., Long-Term Evolution (LTE)), fifth generation (7G) connectivity (e.g., New Radio (NR)), Wi-Fi connectivity, Bluetooth connectivity, and other wireless data transmission standards. The wireless connectivity component 712 is further coupled to one or more antennas 714.

The processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS) as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The memory 724 may be representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes streaming data representation generating component 724A, an output generating component 724C, and a generative artificial intelligence model 724D. The depicted components, and others not depicted, may be configured to perform various aspects of the methods described herein.

Generally, the processing system 700 and/or components thereof may be configured to perform the methods described herein.

Notably, in other aspects, aspects of the processing system 700 may be omitted, such as where the processing system 700 is a server computer or the like. For example, the multimedia processing unit 710, the wireless connectivity component 712, the sensor processing units 716, the ISPs 718, and/or the navigation processor 720 may be omitted in other aspects. Further, aspects of the processing system 700 may be distributed, such as training a model and using the model to generate inferences.

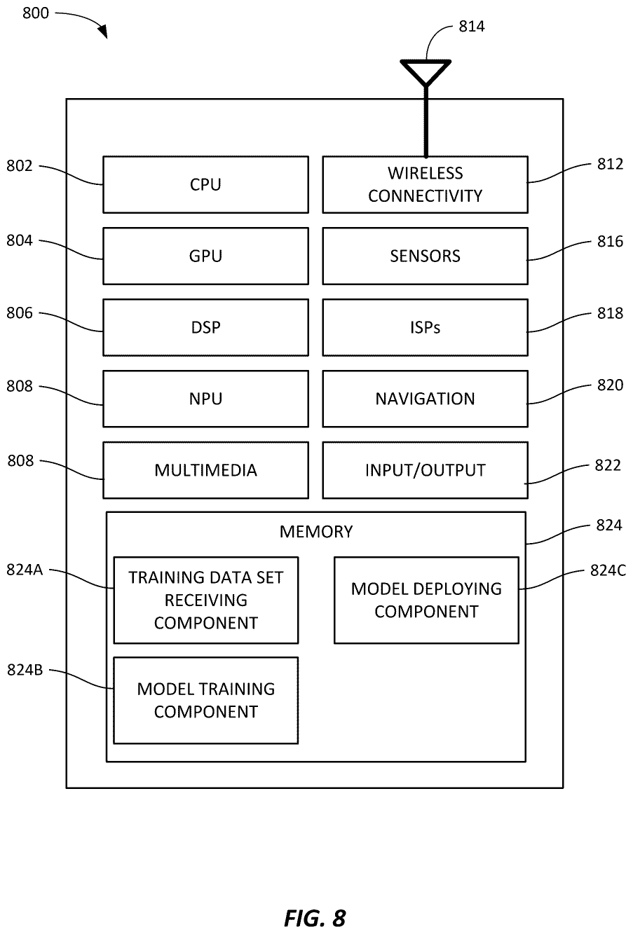

FIG. 8 depicts an example processing system 800 for training a generative artificial intelligence model to asynchronously generate outputs based on streaming data inputs, such as described herein for example with respect to FIG. 6.

The processing system 800 includes a central processing unit (CPU) 802, which in some examples may be a multi-core CPU. Instructions executed at the CPU 802 may be loaded, for example, from a program memory associated with the CPU 802 or may be loaded from a memory 824.

The processing system 800 also includes additional processing components tailored to specific functions, such as a graphics processing unit (GPU) 804, a digital signal processor (DSP) 806, a neural processing unit (NPU) 808, a multimedia processing unit 810, and a wireless connectivity component 812.

In some implementations, the NPU 808 is a part of one or more of the CPU 802, the GPU 804, and/or the DSP 806.

In some examples, the wireless connectivity component 812 may include subcomponents, for example, for 3G connectivity, 4G connectivity (e.g., LTE), 5G connectivity (e.g., NR), Wi-Fi connectivity, Bluetooth connectivity, and other wireless data transmission standards. The wireless connectivity component 812 is further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The memory 824 may be representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes a training data set receiving component 824A, a model training component 824B, and a model deploying component 824C. The depicted components, and others not depicted, may be configured to perform various aspects of the methods described herein.

Generally, the processing system 800 and/or components thereof may be configured to perform the methods described herein.

Notably, in other aspects, aspects of the processing system 800 may be omitted, such as where the processing system 800 is a server computer or the like. For example, the multimedia processing unit 810, the wireless connectivity component 812, the sensor processing units 816, the ISPs 818, and/or the navigation processor 820 may be omitted in other aspects. Further, aspects of the processing system 800 may be distributed, such as training a model and using the model to generate inferences.

### Example Clauses

Implementation details of various aspects are described in the following numbered clauses.

Clause 1: A processor-implemented method for machine learning, comprising: generating a representation of first streaming data; generating a response to the first streaming data using a generative artificial intelligence model, the generated response to the first streaming data being based on previously received streaming data and comprising one or more tokens identifying an action to perform in response to receipt of the first streaming data; and taking one or more first actions based on the response to the first streaming data.

Clause 2: The method of Clause 1, wherein the first streaming data comprises streaming video data and wherein the response to the first streaming data comprises a continue observation token.

Clause 3: The method of Clause 2, further comprising, based on the response comprising the continue observation token: generating a representation of second streaming data; generating a response to the second streaming data using the generative artificial intelligence model, the generated response to the second streaming data being based on at least the first streaming data and the second streaming data; and taking one or more second actions based on the response to the second streaming data.

Clause 4: The method of Clause 3, wherein taking the one or more second actions based on the response to the second streaming data comprises outputting the response in a modality different from a modality associated with the first streaming data and the second streaming data.

Clause 5: The method of any of Clauses 1 through 4, wherein the response to the first streaming data comprises an output response token indicating that the response is to be output to a user of a computing system from which the first streaming data was received.

Clause 6: The method of any of Clauses 1 through 5, wherein the response to the first streaming data comprises a response related to a previously generated response generated by the generative artificial intelligence model based on the previously received streaming data.

Clause 7: The method of any of Clauses 1 through 6, wherein generating the representation of the first streaming data comprises generating one or more input tokens representing the first streaming data.

Clause 8: The method of any of Clauses 1 through 7, wherein the generative artificial intelligence model comprises a model trained to generate at least one of textual responses or audio responses to streaming video inputs.

Clause 9: The method of any of Clauses 1 through 8, wherein the generative artificial intelligence model comprises a model trained to generate the response asynchronously and in parallel with capturing at least second streaming data.

Clause 10: The method of any of Clauses 1 through 9, wherein: the first streaming data comprises video depicting subject motion, and the response to the first streaming data comprises an observation of the depicted subject motion relative to a target subject motion.

Clause 11: The method of any of Clauses 1 through 10, wherein generating the response to the first streaming data comprises: identifying a state in a state machine corresponding to the first streaming data, the state comprising one of a plurality of states in the state machine describing a sequence of activity monitored by the generative artificial intelligence model; and generating the response based on the identified state.

Clause 12: The method of Clause 11, wherein generating the response based on the identified state comprises generating the response based on a comparison of the identified state to a target state for the sequence of activity monitored by the generative artificial intelligence model.

Clause 13: The method of Clause 11 or 12, generating the response based on the identified state comprises generating the response based on a determination that the identified state is identical to a previous state identified by the generative artificial intelligence model for a previous streaming input.

Clause 14: The method of Clause 13, wherein: the identified state comprises a target state for the sequence of activity, and generating the response comprises generating affirmative feedback acknowledging that the user is performing the sequence of activity correctly.

Clause 15: A processor-implemented method of training a generative artificial intelligence model, comprising: receiving a training data set including a plurality of streaming data samples, each respective streaming data sample being labeled with a description of activity depicted by the respective streaming data sample and time data associated with the respective streaming data sample; training the generative artificial intelligence model to asynchronously generate a response to an input sample of streaming data based on the training data set and previously received streaming data; and deploying the trained generative artificial intelligence model.

Clause 16: The method of Clause 15, wherein the description of activity depicted by the respective streaming data sample comprises a state in a state machine identifying an action to be performed based on the respective streaming data sample.

Clause 17: The method of Clause 16, wherein the respective streaming data sample comprises streaming video data and wherein the state in the state machine comprises a continue observation state.

Clause 18: The method of Clause 16 or 17, wherein the state in the state machine comprises a response output state corresponding to detection of a difference between a target state and a state identified in the respective streaming data sample.

Clause 19: The method of any of Clauses 15 through 18, wherein training the generative artificial intelligence model comprises: generating, for each respective streaming data sample, a respective set of tokens representing the respective data sample, and training the generative artificial intelligence model based on the respective set of tokens representing the respective data sample and the description of activity depicted by the respective streaming data sample.

Clause 20: The method of any of Clauses 15 through 19, wherein the generative artificial intelligence model comprises a model trained to generate at least one of textual responses or audio responses to streaming video inputs.

Clause 21: A processing system comprising: at least one memory comprising computer-executable instructions; and one or more processors configured to execute the computer-executable instructions and cause the processing system to perform a method in accordance with any of Clauses 1 through 20.

Clause 22: A processing system comprising means for performing a method in accordance with any of Clauses 1 through 20.

Clause 23: A non-transitory computer-readable medium comprising computer-executable instructions that, when executed by one or more processors of a processing system, cause the processing system to perform a method in accordance with any of Clauses 1 through 20.

Clause 24: A computer program product embodied on a computer-readable storage medium comprising code for performing a method in accordance with any of Clauses 1 through 20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning, comprising:
at least one memory having executable instructions stored thereon; and
one or more processors configured to execute the executable instructions in order to cause the processing system to:
generate a representation of first streaming data;
generate a response to the first streaming data using a generative artificial intelligence model, the generated response to the first streaming data being based on previously received streaming data and comprising one or more tokens identifying an action to perform in response to receipt of the first streaming data; and
take one or more first actions based on the response to the first streaming data.

2. The processing system of claim 1, wherein the first streaming data comprises streaming video data and wherein the response to the first streaming data comprises a continue observation token.

3. The processing system of claim 2, wherein the one or more processors are further configured to cause the processing system to, based on the response comprising the continue observation token:
generate a representation of second streaming data;
generate a response to the second streaming data using the generative artificial intelligence model, the generated response to the second streaming data being based on at least the first streaming data and the second streaming data; and
take one or more second actions based on the response to the second streaming data.

4. The processing system of claim 3, wherein to take the one or more second actions based on the response to the second streaming data, the one or more processors are configured to cause the processing system to output the response in a modality different from a modality associated with the first streaming data and the second streaming data.

5. The processing system of claim 1, wherein the response to the first streaming data comprises an output response token indicating that the response is to be output to a user of a computing system from which the first streaming data was received.

6. The processing system of claim 1, wherein the response to the first streaming data comprises a response related to a previously generated response generated by the generative artificial intelligence model based on the previously received streaming data.

7. The processing system of claim 1, wherein to generate the representation of the first streaming data, the one or more processors are configured to cause the processing system to generate one or more input tokens representing the first streaming data.

8. The processing system of claim 1, wherein the generative artificial intelligence model comprises a model trained to generate at least one of textual responses or audio responses to streaming video inputs.

9. The processing system of claim 1, wherein the generative artificial intelligence model comprises a model trained to generate the response asynchronously and in parallel with capturing at least second streaming data.

10. The processing system of claim 1, wherein:
the first streaming data comprises video depicting subject motion, and the response to the first streaming data comprises an observation of the depicted subject motion relative to a target subject motion.

11. The processing system of claim 1, wherein to generate the response to the first streaming data, the one or more processors are configured to cause the processing system to:
identify a state in a state machine corresponding to the first streaming data, the state comprising one of a plurality of states in the state machine describing a sequence of activity monitored by the generative artificial intelligence model; and
generate the response based on the identified state.

12. The processing system of claim 11, wherein to generate the response based on the identified state, the one or more processors are configured to cause the processing system to generate the response based on a comparison of the identified state to a target state for the sequence of activity monitored by the generative artificial intelligence model.

13. The processing system of claim 11, wherein to generate the response based on the identified state, the one or more processors are configured to cause the processing system to generate the response based on a determination that the identified state is identical to a previous state identified by the generative artificial intelligence model for a previous streaming input.

14. The processing system of claim 13, wherein:
the identified state comprises a target state for the sequence of activity, and
to generate the response, the one or more processors are configured to cause the processing system to generate affirmative feedback acknowledging that the sequence of activity has been correctly performed.

15. A processing system of training a generative artificial intelligence model, comprising:
at least one memory having executable instructions stored thereon; and
one or more processors configured to execute the executable instructions to cause the processing system to:
receive a training data set including a plurality of streaming data samples, each respective streaming data sample being labeled with a description of activity depicted by the respective streaming data sample and time data associated with the respective streaming data sample;
train the generative artificial intelligence model to asynchronously generate a response to an input sample of streaming data based on the training data set and previously received streaming data; and
deploy the trained generative artificial intelligence model.

16. The processing system of claim 15, wherein the description of activity depicted by the respective streaming data sample comprises a state in a state machine identifying an action to be performed based on the respective streaming data sample.

17. The processing system of claim 16, wherein the respective streaming data sample comprises streaming video data and wherein the state in the state machine comprises a continue observation state.

18. The processing system of claim 16, wherein the state in the state machine comprises a response output state corresponding to detection of a difference between a target state and a state identified in the respective streaming data sample.

19. The processing system of claim 15, wherein to train the generative artificial intelligence model, the one or more processors are configured to cause the processing system to:
generate, for each respective streaming data sample, a respective set of tokens representing the respective data sample, and
train the generative artificial intelligence model based on the respective set of tokens representing the respective data sample and the description of activity depicted by the respective streaming data sample.

20. The processing system of claim 15, wherein the generative artificial intelligence model comprises a model trained to generate at least one of textual responses or audio responses to streaming video inputs.

21. A processor-implemented method for machine learning, comprising:
generating a representation of first streaming data;
generating a response to the first streaming data using a generative artificial intelligence model, the generated response to the first streaming data being based on previously received streaming data and comprising one or more tokens identifying an action to perform in response to receipt of the first streaming data; and
taking one or more first actions based on the response to the first streaming data.

22. The method of claim 21, wherein the first streaming data comprises streaming video data and wherein the response to the first streaming data comprises a continue observation token.

23. The method of claim 22, further comprising, based on the response comprising the continue observation token:
generating a representation of second streaming data;
generating a response to the second streaming data using the generative artificial intelligence model, the generated response to the second streaming data being based on at least the first streaming data and the second streaming data; and
taking one or more second actions based on the response to the second streaming data.

24. The method of claim 21, wherein the generative artificial intelligence model comprises a model trained to generate the response asynchronously and in parallel with capturing at least second streaming data.

25. The method of claim 21, wherein:
the first streaming data comprises video depicting subject motion, and
the response to the first streaming data comprises an observation of the depicted subject motion relative to a target subject motion.

26. The method of claim 21, wherein generating the response to the first streaming data comprises:
identifying a state in a state machine corresponding to the first streaming data, the state comprising one of a plurality of states in the state machine describing a sequence of activity monitored by the generative artificial intelligence model; and
generating the response based on the identified state.

27. The method of claim 26, wherein generating the response based on the identified state comprises generating the response based on a comparison of the identified state to a target state for the sequence of activity monitored by the generative artificial intelligence model.

28. The method of claim 26, generating the response based on the identified state comprises generating the response based on a determination that the identified state is identical to a previous state identified by the generative artificial intelligence model for a previous streaming input.

29. The method of claim 28, wherein:
the identified state comprises a target state for the sequence of activity, and
generating the response comprises generating affirmative feedback acknowledging that the sequence of activity has been correctly performed.

30. A processor-implemented method of training a generative artificial intelligence model, comprising:
receiving a training data set including a plurality of streaming data samples, each respective streaming data sample being labeled with a description of activity depicted by the respective streaming data sample and time data associated with the respective streaming data sample;
training the generative artificial intelligence model to asynchronously generate a response to an input sample of streaming data based on the training data set and previously received streaming data; and
deploying the trained generative artificial intelligence model.
